(19) United States
(12) Patent Application Publication
(10) Pub. No.: US 2012/0304042 A1
(43) Pub. Date: Nov. 29, 2012

(54) PARALLEL AUTOMATED DOCUMENT COMPOSITION

(76) Inventors: Jose Bento Ayres Pereira, Palo Alto, CA (US); Niranjan Damera-Venkata, Fremont, CA (US)

(21) Appl. No.: 13/118,396

(22) Filed: May 28, 2011

(51) Int. Cl. G06F 17/00

(52) U.S. Cl. 715/201

(57) ABSTRACT

Systems and methods of parallel automated document composition are disclosed. In an example, a method comprises determining composition scores Φᵢ(A,B) for a document, the composition scores computing in parallel. The method also comprises determining coefficients (τᵢ) in parallel for each of the i pages in the document. The method also comprises composing a document based on the composition scores (Φᵢ) and the coefficients (τᵢ).

### BACKGROUND

Micro-publishing has exploded on the Internet, as evidenced by a staggering increase in the number of blogs and social networking sites. Personalizing content allows a publisher to target content for the readers (or subscribers), allowing the publisher to focus on advertising and tap this increased value as a premium. But while these publishers may have the content, they often lack the design skill to create compelling print magazines, and often cannot afford expert graphic design. Manual publication design is expertise intensive, thereby increasing the marginal design cost of each new edition. Having only a few subscribers does not justify high design costs. And even with a large subscriber base, macro-publishers can find it economically infeasible and logistically difficult to manually design personalized publications for all of the subscribers. An automated document composition system could be beneficial.

### BRIEF DESCRIPTION OF THE DRAWINGS

FIG. 1 shows an example of a template for a single page of a mixed-content document.

FIG. 2 shows the example template in FIG. 1 where two images are selected for display in the image fields.

FIG. 3A is a high-level diagram showing an example implementation of automated document composition using PDM.

FIG. 3B is a high-level diagram showing an example template library.

FIGS. 4A-D show an example variable template in a template library.

FIGS. 5A-B are high-level illustrations of example tasks in parallel architecture computing units.

FIG. 6 is a high-level block diagram showing example hardware which may be implemented for automated document composition.

FIG. 7 is a flowchart showing example operations for automated document composition on parallel graphics hardware.

### DETAILED DESCRIPTION

Automated document composition is a compelling solution for micro-publishers, and even macro-publishers. Both benefit by being able to deliver high-quality, personalized publications (including but not limited to, newspapers, books and magazines), while reducing the time and associated costs for design and layout. In addition, the publishers do not need to have any particular level of design expertise, allowing the micro-publishing revolution to be transferred from being strictly “online” to more traditional printed publications.

Mixed-content documents used in both online and traditional print publications are typically organized to display a combination of elements that are dimensioned and arranged to display information to a reader (e.g., text, images, headers, sidebars), in a coherent, informative, and visually aesthetic manner. Examples of mixed-content documents include articles, flyers, business cards, newsletters, website displays, brochures, single or multi page advertisements, envelopes, and magazine covers, just to name a few examples. In order to design a layout for a mixed-content document, a document designer selects for each page of the document a number of elements, element dimensions, spacing between elements called “white space,” font size and style for text, background, colors, and an arrangement of the elements.

Arranging elements of varying size, number, and logical relationship onto multiple pages in an aesthetically pleasing manner can be challenging, because there is no known universal model for human aesthetic perception of published documents. Even if the published documents could be scored on quality, the task of computing the arrangement that maximizes aesthetic quality is exponential to the number of pages and is generally regarded as intractable.

The Probabilistic Document Model (PDM) can be used to address these classical challenges by allowing aesthetics to be encoded by human graphic designers into elastic templates, and efficiently computing the best layout while also maximizing the aesthetic intent. While the computational complexity of the serial PDM algorithm is linear in the number of pages and in content units, the performance can be insufficient for interactive applications, where either a user is expecting a preview before placing an order, or is expecting to interact with the layout in a semi-automatic fashion.

Advances in computing devices have accelerated the growth and development of software-based document layout design tools and, as a result, have increased the efficiency with which mixed-content documents can be produced. A first type of design tool uses a set of gridlines that can be seen in the document design process but are invisible to the document reader. The gridlines are used to align elements on a page, allow for flexibility by enabling a designer to position elements within a document, and even allow a designer to extend portions of elements outside of the guidelines, depending on how much variation the designer would like to incorporate into the document layout. A second type of document layout design tool is a template. Typical design tools present a document designer with a variety of different templates to choose from for each page of the document.

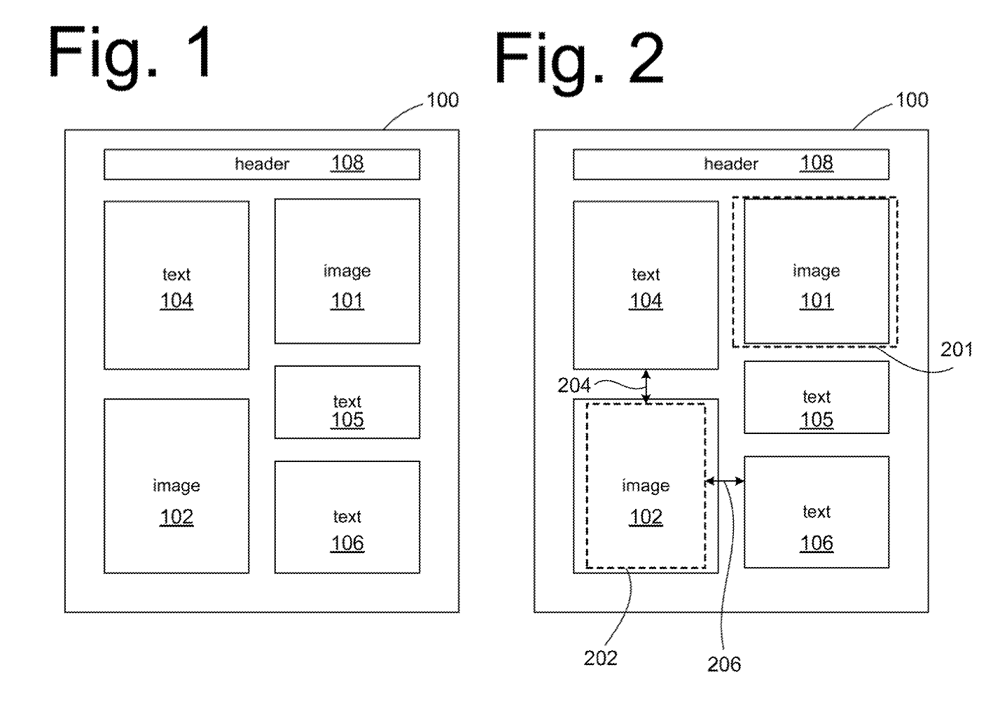

FIG. 1 shows an example of a template 100 for a single page of a mixed-content document. The template 100 includes two image fields 101 and 102, three text fields 104-106, and a header field 108. The text, image, and header fields are separated by white spaces. A white space is a blank region of a template separating two fields, such as white space 110 separating image field 101 from text field 105. A designer can select the template 100 from a set of other templates, input image data to fill the image fields 101 and text data to fill the text fields 104-106 and the header 108.

However, many procedures in organizing and determining an overall layout of an entire document continue to require numerous tasks that are to be completed by the document designer. For example, it is often the case that the dimensions of template fields are fixed, making it difficult for document designers to resize images and arrange text to fill particular fields creating image and text overflows, cropping, or other unpleasant scaling issues.

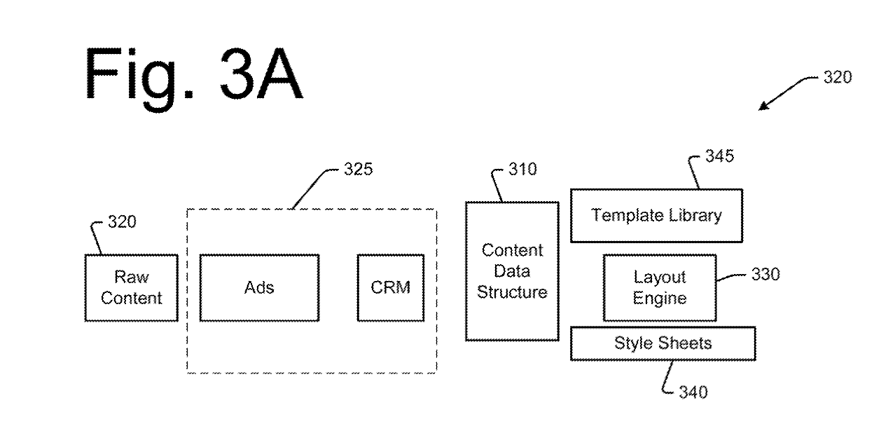

FIG. 2 shows the template 100 where two images, represented by dashed-line boxes 201 and 202, are selected for display in the image fields 101 and 102. As shown in the example of FIG. 2, the images 201 and 202 do not fit appropriately within the boundaries of the image fields 101 and 102. With regard to the image 201, a design tool may be configured to crop the image 201 to fit within the boundaries of the image field 101 by discarding what it determines as peripheral portions of the image 201, or the design tool may attempt to fit the image 201 within the image field 101 by rescaling the aspect ratio of the image 201, resulting in a visually displeasing distorted image 201. Because image 202 fits within the boundaries of image field 102 with room to spare, white spaces 204 and 206 separating the image 202 from the text fields 104 and 106 exceed the size of the white spaces separating other elements in the template 100 resulting in a visually distracting uneven distribution of the elements. The design tool may attempt to correct for this by rescaling the aspect ratio of the image 202 to fit within the boundaries of the image field 102, also resulting in a visually displeasing distorted image 202.

The systems and methods described herein use automated document composition for generating mixed-content documents. Automated document composition can be used to transform marked-up raw content into aesthetically-pleasing documents. Automated document composition may involve pagination of content, determining relative arrangements of content blocks and determining physical positions of content blocks on the pages.

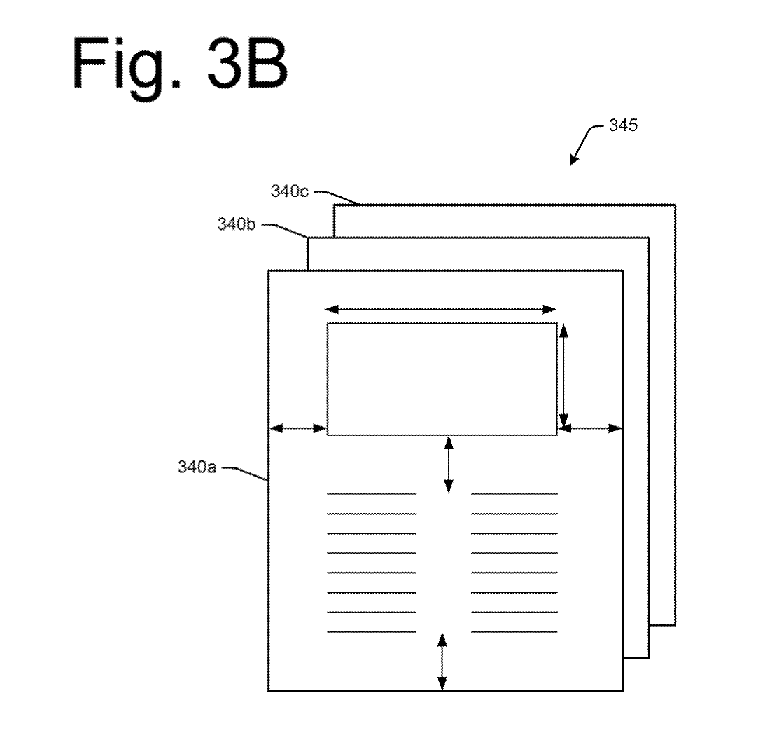

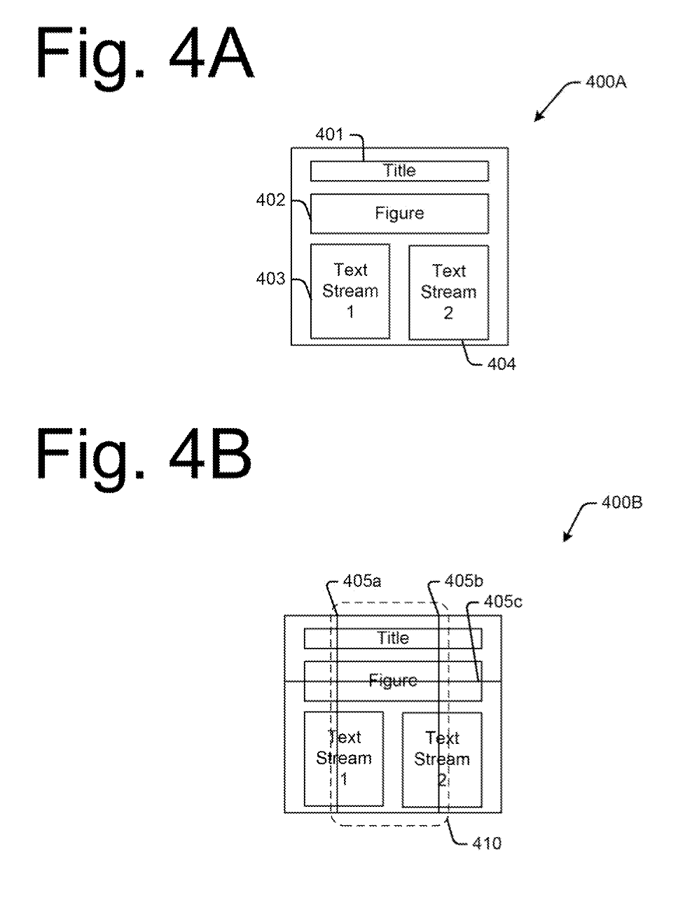

FIG. 3A is a high-level diagram 300 showing an example implementation of automated document composition using PDM. The content data structure 310 represents the input to the layout engine. In an example, the content data structure is an XML file. In a typical magazine example, there may be a stream of text, a stream of figures, a stream of sidebars, a stream of pull quotes, a stream of advertisements, and logical relationships between them. For purposes of illustration, FIG. 3A shows a stream of text blocks, a stream of figures, and the logical linkages.

In the example shown in FIG. 3A, the content 320 is decoupled from the presentation 325 which allows variation in the size, number and relationship among content blocks, and is the input to the automated publishing engine 330. Adding or deleting elements may be accomplished by addition or deletion of sub-trees in the XML structure 310. Content modifications simply amount to changing the content of an XML leaf-node.

Each content data structure 310 (e.g., an XML file) is coupled with a template or document style sheet 340 from a template library 345. Content blocks within the XML file 310 have attributes that denote type. For example, text blocks may be tagged as head, subhead, list, para, caption. The document style sheet 340 defines the type definitions and the formatting for these types. Thus the style sheet 340 may define a head to use Arial bold font with a specified font size, line spacing, etc. Different style sheets 340 apply different formatting to the same content data structure 310.

It is noted that type definitions may be scoped within elements, so that two different types of sidebars may have different text formatting applied to text with a subhead attribute. The style sheet also defines overall document characteristics such as, margins, bleeds, page dimensions, spreads, etc. Multiple sections of the same document may be formatted with different style sheets.

Graphic designers may design a library of variable templates. An example template library 345 is shown in high-level in FIG. 3B. Having human-developed templates 340a-c solves the challenge of creating an overarching model for human aesthetic perception. Different styles can be applied to the same template via style sheets as discussed above.

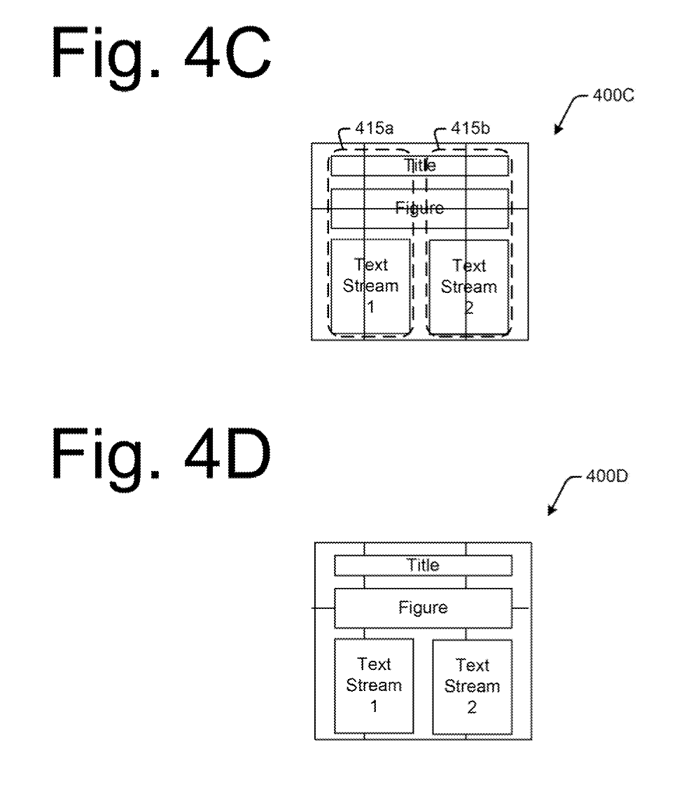

FIGS. 4A-D shows an example variable template in the template library. The template parameters (Θ's) represent white space, figure scale factors, etc. The design process to create a template may include content block layout, specification of dimension (x and y) optimization paths and path groups, and specification of prior probability distributions for individual parameters.

A content block layout is illustrated in FIG. 4A. A designer may place content rectangles 401-404 on the design canvas 400A. Three types of content blocks are supported in this example, including title 401, FIG. 402, and text blocks 403-404. It is noted that text blocks 403-404 represent streams of text sub-blocks, and may include headings, subheadings, list items, etc. The types and formatting of sub-blocks that go in a text stream are defined in the document style sheet. Each template has attributes, such as background color, background image, first page template flag, last page template flag etc. which allow for common template customizations.

To specify paths and path groups, the designer may draw vertical and horizontal lines 405a-c across the page indicating paths what the layout engine optimizes. Specification of a path indicates the designer goal that content blocks and whitespace along the path conform to specified path heights (widths). These path lengths may be set to the page height (width) to encourage the layout engine to produce full pages with minimized under and overfill. Paths may be grouped together to indicate that text flow from one path to the next. FIG. 4B is a design canvas 400B showing an example path 405a-c and path group 410 specification. Further, content may be grouped together as a sidebar. FIG. 4C is a design canvas 400C showing a sidebar grouping 415a-b where the figure and text stream are grouped together into a sidebar. Thus FIG. 4B shows two Y paths grouped into a single Y-path group 410, and FIG. 4C shows two Y paths grouped into two Y-Path groups 415a-b. The second Y-path group 415b contains a sidebar grouping. Text is not allowed to flow outside a sidebar or from one Y-path group to the next.

When the designer selects variable entry (e.g., in the user interface), the figure areas and X and Y whitespaces are highlighted for parameter specification (e.g., as illustrated by design canvas 400D in FIG. 4D). The parameters are set to fixed values inferred from the position on the canvas. The designer clicks on parameters that are to be variable and enters a minimum value, a maximum value, a mean value and a precision value for each desired variable. This process specifies a “prior” Gaussian distribution for each of the template parameters. It is a “prior” Gaussian distribution in the sense that it is specified before seeing actual content. For figures, width and height ranges, and a precision value for the scale factor are specified. The mean value of the scale parameter is automatically determined by the layout engine based on the aspect ratio of an actual image so as to make the figure as large as possible without violating the specified range conditions on width and height. Thus the scale parameter of a figure has a truncated Gaussian distribution with truncation at the mean. The designer can make aesthetic judgments regarding relative block placement, whitespace distribution, figure scaling etc. The layout engine strives to respect this designer “knowledge” as encoded into the prior parameter distributions.

The layout engine includes three components. A parser parses style sheets, templates, and input content into internal data structures. An inference engine computes the optimal layouts, given content. A rendering engine renders the final document.

There are three parsers, one each for style sheets, content, and templates. The style sheet parser reads the style sheet for each content stream and creates a style structure that includes document style and font styles. The content parser reads the content stream and creates an array of structures for figures, text and sidebars respectively.

The text structure array (also referred to herein as a “chunk array”) includes information about each independent “chunk” of text that is to be placed on the page. A single text block in the content stream may be chunked as a whole if text cannot flow across columns or pages (e.g., headings and text within sidebars). However, if the text block is allowed to flow (e.g., paragraphs and lists), the text is first decomposed into smaller chunks that are rendered atomically. Each structure in the chunk array can include an index in the array, chunk height, whether a column or page break is allowed at the chunk, the identity of the content block to which the chunk belongs, the block type and an index into the style array to access the style required to render the chunk. The height of a chunk is determined by rendering the text chunk at all possible text widths using the specified style in an off screen rendering process. In an example, the number of lines and information regarding the font style and line spacing is used to calculate the rendered height of a chunk.

Each figure structure in the figure array encapsulates the figure properties of an actual figure in the content stream such as width, height, source filename, caption and the text block identity of a text block which references the figure. Figure captions are handled similar to a single text chunk described above allowing various caption widths based on where the caption actually occurs in a template. For example, full width captions span text columns, while column width captions span a single text column.

Each content sidebar may appear in any sidebar template slot (unless explicitly restricted), so the sidebar array has elements which are themselves arrays with individual elements describing allocations to different possible sidebar styles. Each of these structures has a separate figure array and chunk array for figures and text that appear within a particular template sidebar.

The inference engine is part of the layout engine. Given the content, style sheet, and template structures, the inference engine solves for a desired layout of the given content. In an example, the inference engine simultaneously allocates content to a sequence of templates chosen from the template library, and solves for template parameters that allow maximum page fill while incorporating the aesthetic judgments of the designers encoded in the prior parameter distributions. The inference engine is based on a framework referred to as the Probabilistic Document Model (PDM), which models the creation and generation of arbitrary multi-page documents.

A given set of all units of content to be composed (e.g., images, units of text, and sidebars) is represented by a finite set c that is a particular sample of content from a random set C with sample space comprising sets of all possible content input sets. Text units may be words, sentences, lines of text, or whole paragraphs. Text units may be words, sentences, lines of text, or whole paragraphs. To use lines of text as an atomic unit for composition, each paragraph is decomposed first into lines of fixed column width. This can be done if text column widths are known and text is not allowed to wrap around figures. This method is used in all examples due to convenience and efficiency.

The term c′ denotes a set comprising all sets of discrete content allocation possibilities over one or more pages, starting with and including the first page. Content subsets that do not form valid allocations (e.g., allocations of non-contiguous lines of text) do not exist in c′. If there are 3 lines of text and 1 floating figure to be composed, e.g., c={l₂, l₃, f₁} while c′={{l₁},{l₁, l₂}, {l₁, l₂, l₃}, {f₁}, {l₁, f₁}, {l₁, l₂, f₁},{l₁, l₂, l₃, f₁}}∪{0}. It is noted that the specific order of elements within an allocation set is not necessary, because {l₁, l₂, f₁} and {l₁, f₁, l₂} refer to an allocation of the same content. However an allocation {l₁, l₃, f₁}∉c′ means that lines 1 and 3 cannot be in the same allocation without including line 2. In addition, c′ includes the empty set to allow for the possibility of a null allocation.

The index of a page is represented by i≧0. Cᵢ is a random set representing the content allocated to page i. C≦i∈c′ is a random set of content allocated to pages with index 0 through i. Hence:

C_{≦i}′=∪ⱼ₌₀ⁱCⱼ.

If C_{≦i}=C_{≦i-1}, then Cᵢ=0 (i.e., page i has no content allocated). For convenience of this discussion, C_{≦-1}=0 and all pages i≧0 have valid content allocations to the previous i−1 pages.

The probabilistic document model (PDM) is a probabilistic framework for adaptive document layout that supports automated generation of paginated documents for variable content. PDM encodes soft constraints (aesthetic priors) on properties, such as, whitespace, image dimensions, and image rescaling preferences, and combines all of these preferences with probabilistic formulations of content allocation and template choice into a unified model. According to PDM, the i^{th} page of a probabilistic document may be composed by first sampling random variable Tᵢ from a set of template indices with a number of possible template choices (representing different relative arrangements of content), sampling a random vector Θᵢ of template parameters representing possible edits to the chosen template, and sampling a random set Cᵢ of content representing content allocation to that page (or “pagination”). Each of these tasks is performed by sampling from an underlying probability distribution.

Thus, a random document can be generated from the probabilistic document model by using the following sampling process for page i≧0 with C_{≦-1}=0:
sample template tᵢ from [symbol] ᵢ(Tᵢ)
sample parameters θᵢ from [symbol] (Θᵢ|tᵢ)
sample content c_{≦i} from [symbol] (C_{≦i}|c_{≦i-1;} θ_{i;} tᵢ)

cᵢ=c_{≦i}−c_{≦i-1}

The sampling process naturally terminates when the content runs out. Since this may occur at different random page counts each time the process is initiated, the document page count I is itself a random variable defined by the minimal page number at which C_{≦i}=c. A document V in PDM is thus defined by a triplet D of random variables representing the various design choices made in the above equations.

For a specific content c, the probability of producing document D of I pages via the sampling process described in this section is simply the product of the probabilities of all design (conditional) choices made during the sampling process. Thus,

$$ℙ ( D ; I ) = {\prod }_{i = 0}^{I - 1} ℙ ( {C}_{\leq i} \vert {C}_{\leq i - 1} , {Θ}_{i} , {T}_{i} ) ℙ ( {Θ}_{i} \vert {T}_{i} ) {ℙ}_{i} ( {T}_{i} )$$

The task of computing the optimal page count and the optimizing sequences of templates, template parameters, content allocations that maximize overall document probability is referred to herein as the model inference task, which can be expressed as:

$$( {D}^{*} , {I}^{*} ) = {argmax }_{D , I \geq 1} ℙ ( D ; I )$$

The optimal document composition may be computed in two passes. In the forward pass, the following coefficients are recursively computed, for all valid content allocation sets A [symbol] B as follows:

$$Ψ ( A , B , T ) = {max}_{Θ} ℙ ( A \vert B , Θ , T ) ℙ ( Θ \vert T )$$

$${Φ}_{i} ( A , B ) = {max}_{T ∈ {Ω}_{i}} Ψ ( A , B , T ) {ℙ}_{i} ( T ) , i \geq 0 , \\ {τ}_{i} ( A ) = {max}_{B} {Φ}_{i} ( A , B ) {τ}_{i - 1} ( B ) , i \geq 1$$

In the equations above, τ₀(A)=Φ₀(A, 0). Computation of τᵢ(A) depends on Φᵢ(A, B), which in turn depends on ψ(A, B, T). In the backward pass, the coefficients computed in the forward pass are used to infer the optimal document. This process is very fast, involving arithmetic and lookups. The entire process is dynamic programming with the coefficients τᵢ(A), Φᵢ(A, B) and ψ(A, B, T) playing the role of dynamic programming tables. The following discussion focuses on parallelizing the forward pass of PDM inference, which is the most computationally intensive part.

The innermost function ψ(A, B, T) can be determined as a score of how well content in the set A-B is suited for template T. This function is the maximum of a product of two terms. The first term [symbol] ( [symbol] |B_{;} Θ_{;} T) represents how well content fills the page and respects figure references, while the second term [symbol] (Θ|T) assesses how close, the parameters of a template are to the designer's aesthetic preference. Thus the overall probability (or “score”) is a tradeoff between page fill and a designer's aesthetic intent. When there are multiple parameters settings that fill the page equally well, the parameters that maximize the prior (and hence are closest to the template designer's desired values) are favored.

The function Φᵢ(A, B) scores how well content A-B can be composed onto the i^{th} page, considering all possible relative arrangements of content (templates) allowed for that page. [symbol] ᵢ(T) allows the score of certain templates to be increased, thus increasing the chance that these templates are used in the final document composition.

Finally function τᵢ(A) is a pure pagination score of the allocation A to the first i pages. The recursion τᵢ(A) means that the pagination score for an allocation A to the first i pages, τᵢ(A) is equal to the product of the best pagination score over all possible previous allocations B to the previous (i−1) pages with the score of the current allocation A-B to the i^{th} page (A, B).

In parallel computation, three types of degrees of dependency can be distinguished among the computations: (a) independent computations, (b) dependent computations, and (c) partially dependent computations.

An example of independent computations is the sums involved in the component-wise sum of two vectors (a, b). The sum of each component, (aᵢ+bᵢ) is unrelated to the sum the other components. Therefore, it does not matter if the threads to which each of these sums is assigned can communicate with each other.

An example of dependent computations is the calculations involved in obtaining all the values of a recursion, such as xᵢ₊₁=f(xᵢ). Proceeding to compute x₁₀ occurs after computing x₉. Hence, all of these computations can be computed by the same thread sequentially. There can be less benefit in having different threads compute these different xᵢ, either inside different thread-blocks or using the same thread-blocks.

An example of partially dependent computations is the comparisons involved in determining the maximum value over a set of values using parallel reduction, e.g., max_{ic{1, 2, . . . 32}} aᵢ. At an initial stage, b1 is computed as b₁=max{a₁, a₁₇}, b2=max{a₂, a₁₈}, . . . b₁₆=max{a₁₆, a₃₂}. However, computations cannot proceed to the next process, e.g., computing c₁=max{b₁, b₈}, c₂=max{b₂, b₉}, . . . c₈=max{b₈, b₁₆}), until all b's have been calculated. In short, there is some dependency among the computations, and although at a given level (e.g., bᵢs level) each comparison can be done in a separate thread, all threads should belong to the same block so that after each process the output can synchronize before going to the next process in the reduction.

The computation of the coefficients Φᵢ(A, B) is the most intensive task. The parallelism in just computing i can be different from the parallelism in the computation of τᵢs (with the Φᵢs being computed on the fly inside the same kernel). Therefore, the Φᵢ coefficients may be pre-computed, and then later τᵢ can be computed. This chronology allows more freedom in optimizing the bottle neck of the whole program without creating a new bottle neck in the computation of the τᵢ, which can now be optimized.

To simplify the explanations that follow, assume in an example that Φᵢ,i, i≧1 is independent of i. For each pair A, B, the coefficient (A, B) can be computed in parallel. However, it is also an empirical fact that if B is in some sense close to B′ (for example, differing in what corresponds to just a few lines), then solving line 3 of the algorithm (associated with the procedure) to compute i with B results in a solution Θᵢ* close to 73 ᵢ*′ which represents the solution when solving with B′. Accordingly, if when solving with B′, the determination starts with Θᵢ* as the initial estimate of the solution, and converges quicker to Θᵢ*′. Hence, choosing to determine Φ(A, B) for different As in parallel, but for a fixed A and different Bs in sequence, and in an order that favors close Bs to be consecutive. This allows use of the solution for the current B to speed up the solution for the next B′. The maximum over templates T can also be determined in parallel for fixed A and B.

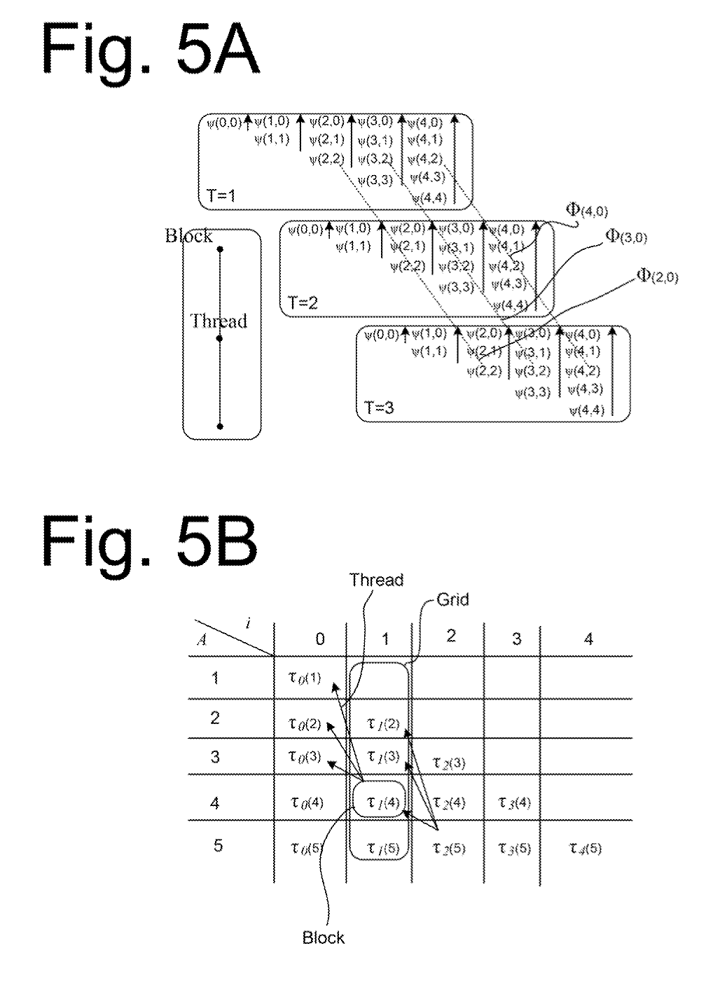

FIGS. 5A-B are a high-level illustrations showing which processing task goes into each of the parallel architecture computing units. FIG. 5A illustrates parallelism in computing Φ(A, B). FIG. 5B illustrates parallelism in computing τ(A). The illustrations provide an idea of what is to be computed in parallel (versus what is computed in series) for the calculation of the Φs and τs. Examples of parallel computing will be described in more detail below. In FIGS. 5A-B, both As and Bs are associated with a number. Close numbers represent close sets.

Parameters Φ can also be determined in parallel. In an example, each thread-block is associated with a particular A (e.g., the notation A=thread.block.id( )) and each thread-block computes in sequence Φ(A, B) for the associated A and all Bs. To sequence threads inside each thread-block, synchronization mechanisms may be used. Inside each thread-block, each thread is associated with a particular template T (e.g., the notation T=thread.id( )). At each block the thread-block (now considering a particular A and B) solves the maximization over T by parallel reduction over T. The parallel reduction is most efficiently implemented using shared memory. Initially, each thread computes a ψ (A, B, T) and stores the solution in an array in shared memory. Then, parallel reduction of this array is performed to search for a maximum value. An example of procedure is described by algorithm 1.

Algorithm 1
Parallel computation of Φ

1: A = thread.block.id( ); T = thread.id( )
2: Θ_{local} = InitTheta( )
3: for all B: 0 ⊂ B ⊂ A
4: {Ψ_{shared}(T), Θlocal} = SolveForTheta(A, B, T, Θ_{local})
5: sync( )
6: for offset = N_{T}/2 down to 1 do
7: if T < offset then
8: Ψ_{shared}(T) = max {Ψ_{shared}(T), Ψ_{shared}(T + offset)}
9: endif
10: sync( )
11: offset = offset/2
12: end for
13: if T=0 then
14: Φ_{global}(A, B) = Ψ_{shared}(T)
15: end if
16: end for

In algorithm 1, Ψ_{shared}(.) is an array in local memory of length equal to the dimensions of the number of templates (N_{T}), and Θ_{local}(.) is an array in local memory of length equal to the dimensions of Θ. If N_{T} is a power of two, then Φ_{global}(.,.) is a double array in global memory where all the computed coefficients Φ(A, B) are stored. In addition, if both the templates and content sets are ordered, then writing T=0 denotes choosing the fifth set from the ordering of sets. Hence, T=T+1 corresponds to moving to the next template. The For-loop over subsets B⊂A puts “close” Bs in consecutive order. For example, B and B+1 might differ in just a single line of text. SolveForTheta(.,.,.,.) is a function that computes both the maximum and the maximizing argument Θ in line 3 of algorithm 1 to compute Φᵢ starting from a given initial condition. The function sync( ) waits for all threads inside the thread-block to reach that point before moving on. InitTheta( ) is a function that outputs an initialization value for e.

Even when all Φ(A, B) coefficients are computed, there is still some gain in computing the τᵢ coefficients in parallel. An example procedure is described by algorithm 2.

Algorithm 2
Parallel computation of τᵢ

```
  1: A = thread.block.id( ); B = thread.id( )
  2: τ_{shared}(B) = Φ_{global}(A, B) τ_{global}(i − 1, B)
  3: sync( )
  4: for offset = Nₜₑₘₚ/2 down to 1 do
  5: if B < offset then
  6: τ_{shared}(B) = max { τ_{shared}(B), τ_{shared}(B + offset)}
  7: endif
  8: sync( )
  9: offset = offset/2
10: end for
11: if B=0 then
12: τ_{global}(i, A) = τ_{shared}(B)
13: endif
```

Although the computation of τᵢs is a recursion, at each process it involves a search of a maximum over a discrete set which can be accelerated using parallel reduction. Using algorithm 2, several kernel calls are made to determine τᵢ(A) VA, one for each index i sequentially. For each fixed i, the kernel launches a thread-grid of size equal to the number of subsets A⊂C. Each block in the grid is responsible for a specific A. Each thread inside each block is associated with a specific B⊂A, recovers Φ(A, B) τᵢ₋₁(B) from global memory, and stores it in a temporary vector in shared memory, τ_{shared}(.). If this is a temporary vector with a fixed length, then Nₜₑₘₚ is large enough to accommodate each value associated with each subsets B of any A, and entries that are not used are set to −1 to avoid interfering with the process of computing the maximum value. To simplify the pseudo-code, Nₜₑₘₚ can be set to a power of two. Finally, the block searches the maximum over this vector using parallel reduction, and stores the value in global memory, τ_{global}(i, A).

The algorithms discussed above describe example procedures for determining the value of Φ(A, B) and τᵢ(A). If the maximizing template and layout parameter and the maximizing set 13 for each A are stored, then after all the τᵢ(A) are computed, implementation of the determination of the optimal document becomes apparent.

In an example, the algorithms described above may be implemented using a NVIDIA Tesla C2050 card (or any similar graphics card with parallel computing capabilities). This example illustrates how to allocate the work load among different computers in a computer cluster. Taking the logarithm on the score of a document, all the products become sums and all the previous recursions are quicker to compute.

Although from a user perspective, threads can execute distinct code, in practice the actual hardware cores handling each thread may not be able to execute different instructions. At the hardware level, threads are organized in groups of size 32, often referred to as “warps.” Each warp executes the same instruction, but over a different set of data.

Therefore, all thread blocks may implement a multiple of 32 threads. It is noted that fewer threads may be used, but some warps may be underutilized. If 32 threads are used, it is convenient to also have a multiple of 32 templates. If that is not the case, one template can be used with a given layout parameters domain, and be split into two, templates, each with part of the initial parameter domain. This process can be used until the number of templates is a multiple of 32.

If consecutive threads in a warp access consecutive memory positions, then there is memory alignment and maximum transfer bit rate. Accordingly, data associated with consecutive templates can be stored in consecutive memory positions.

Since each thread-block is only assigned to a single warp, and because there are fourteen warps in most streaming multiprocessors (e.g., a Tesla C2050 processor), fourteen different thread-blocks may be used to make use of all available hardware cores (i.e., the grid has a size greater than 14). In addition, each block may have a predetermined number of threads, and each grid may have a predetermined number of blocks. For a Tesla C2050 processor, for example, the maximum dimension of each block is 1024×1024×64 and the maximum number of threads per block is 1024. Therefore, the maximum dimensions of a grid is 65535×65535×1.

For the computation of Φ, the number of threads for each block implies that the number of templates should be smaller than 1024. The limited number of blocks for each grid implies that not all coefficients Φ can be computed in the same kernel call. In fact, while a grid size of 65535×65535×1 seems large, the combinatoric nature of the automated document composition can quickly result in a large number of (A, B) sets for which to compute Φ(A, B).

Therefore, in one example the pre-computation of these coefficients may be handled in batches. After each batch is computed, the τᵢ coefficients that use these coefficients for corresponding calculations may be computed and stored. Then the values of Φ for the stored batch are discarded, and the next batch is computed. This enables a small function to be used that calls the computing kernels multiple times. For the computation of τᵢ, the limitation on the total number of number of threads per block (1024 at most) makes each thread search over multiple Bs.

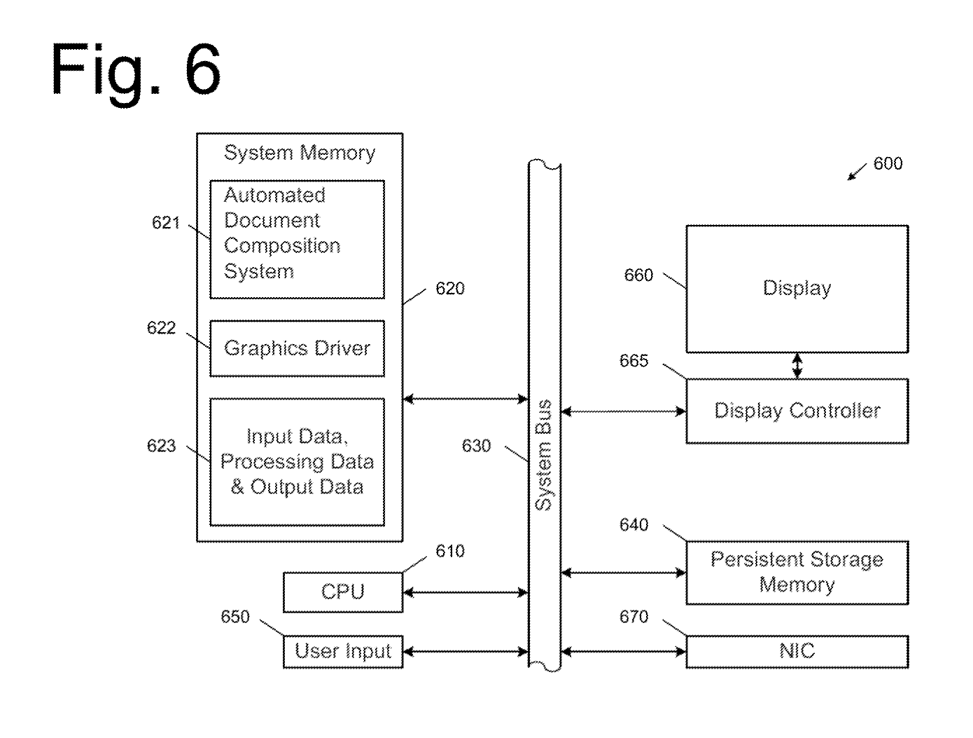

Before continuing, it is noted that the computations described herein may be implemented on any suitable platform. An example of a suitable platform is described with reference to FIG. 6, however, the systems and methods described herein are not intended to be limited to implementation on any particular type of platform.

FIG. 6 is a high-level block diagram 600 showing example hardware which may be implemented for automated document composition. In this example, a computer system 600 is shown which can implement any of the examples of the automated document composition system 621 that are described herein. The computer system 600 includes a processing unit 710 (CPU), a system memory 620, and a system bus 630 that couples processing unit 610 to the various components of the computer system 600. The processing unit 610 typically includes one or more processors, each of which may be in the form of any one of various commercially available processors. The system memory 620 typically includes a read only memory (ROM) that stores a basic input/output system (BIOS) that contains start-up routines for the computer system 600 and a random access memory (RAM). The system bus 146 may be a memory bus, a peripheral bus or a local bus, and may be compatible with any of a variety of bus protocols, including PCI, VESA, Microchannel, ISA, and EISA. The computer system 600 also includes a persistent storage memory 640 (e.g., a hard drive, a floppy drive, a CD ROM drive, magnetic tape drives, flash memory devices, and digital video disks) that is connected to the system bus 630 and contains one or more computer-readable media disks that provide non-volatile or persistent storage for data, data structures and computer-executable instructions.

A user may interact (e.g., enter commands or data) with the computer system 600 using one or more input devices 650 (e.g., a keyboard, a computer mouse, a microphone, joystick, and touch pad). Information may be presented through a user interface that is displayed to a user on the display 660 (implemented by, e.g., a display monitor), which is controlled by a display controller 665 (implemented by, e.g., a video graphics card). The computer system 600 also typically includes peripheral output devices, such as a printer. One or more remote computers may be connected to the computer system 600 through a network interface card (NIC) 670.

As shown in FIG. 6, the system memory 620 also stores the automated document composition system 621, a graphics driver 622, and processing information 623 that includes input data, processing data, and output data.

The automated document composition system 621 can include discrete data processing components, each of which may be in the form of any one of various commercially available data processing chips. In some implementations, the automated document composition system 621 is embedded in the hardware of any one of a wide variety of digital and analog computer devices, including desktop, workstation, and server computers. In some examples, the automated document composition system 621 executes process instructions (e.g., machine-readable instructions, such as but not limited to computer software and firmware) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

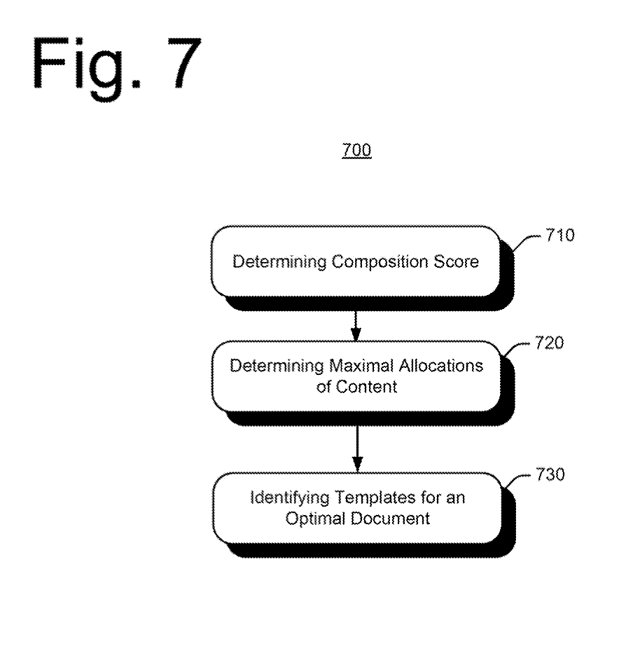

FIG. 7 is a flowchart illustrating example operations of parallel automated document composition which may be implemented. Operations 700 may be embodied as machine readable instructions on one or more computer-readable medium. When executed on a processor, the instructions cause a general purpose computing device to be programmed as a special-purpose machine that implements the described operations. In an example implementation, the components and connections depicted in the figures may be used.

An example of a method of parallel automated document composition may be carried out by program code stored on non-transient computer-readable medium and executed by a processor.

In operation 710, determining composition scores Φᵢ(A, B) for a document, the composition scores computing in parallel.

In operation 720, determining coefficients (τᵢ) in parallel for each of the i pages in the document.

In operation 730, composing a document based on the composition scores (Φᵢ) and the coefficients (τᵢ).

The operations shown and described herein are provided to illustrate example implementations. It is noted that the operations are not limited to the ordering shown. Still other operations may also be implemented.

In an example of further operation, A and B are subsets of the original content C.

In another example, the composition score is for allocating content (A) to the first i pages in a document, and allocating content (B) to the first i−1 pages in the document.

In further operations, the composition score is computed by maximizing individual template scores ψ (A, B, T). In an example, the composition score represents how well content A-B fits the ith page over templates T from a library of templates that may be used to lay out of the content.

Further operations may include determining the composition score Φ(A, B) before determining the maximal allocations (τ). Each content pair (A, B), the composition score Φ(A, B) is computed in parallel.

In further operations, the composition score Φ(A, B) is computed in parallel for different As and fixed Bs. The composition score Φ(A, B) may be computed in sequence for a fixed A and different Bs. The composition score Φ(A, B) may be computed in parallel for fixed As and fixed Bs.

It is noted that the example embodiments shown and described are provided for purposes of illustration and are not intended to be limiting. Still other embodiments are also contemplated.

1. A method of parallel automated document composition, comprising:
determining composition scores Φᵢ(A,B) for a document, the composition scores computing in parallel;
determining coefficients (τᵢ) in parallel for each of the i pages in the document; and
composing a document based on the composition scores (Φᵢ) and the coefficients (τᵢ).

2. The method of claim 1, wherein A and B are subsets of original content.

3. The method of claim 1, wherein the composition scores is for allocating content (A) to the first i pages in a document, and allocating content (B) to the first i−1 pages in the document.

4. The method of claim 1, wherein the composition scores is computed by maximizing individual template scores ψ (A, B, T).

5. The method of claim 1, wherein the composition scores represents how well content A-B fits the ith page over templates T from a library of templates that may be used to lay out of the content.

6. The method of claim 1, further comprising determining the composition scores Φᵢ (A, B) before determining the coefficients (τ).

7. The method of claim 1, wherein for each content pair (A, B), the composition scores Φᵢ (A, B) is computed in parallel.

8. The method of claim 1, wherein the composition scores Φᵢ (A, B) is computed in parallel for different As and fixed Bs.

9. The method of claim 1, wherein the composition scores Φ(A, B) is computed in sequence for a fixed A and different Bs.

10. The method of claim 1, wherein the composition scores Φ(A, B) is computed in parallel for fixed As and fixed Bs.

11. A system comprising a computer readable storage to store program code executable for parallel automated document composition, the program code comprising instructions to:
compute in a parallel processing environment, composition scores Φᵢ(A, B);
compute in a parallel processing environment, coefficients (τᵢ) for each of the i pages in the document; and
produce a document based on the composition scores (Φᵢ) and the coefficients (τᵢ).

12. The system of claim 11, wherein the composition scores Φᵢ (A, B) is computed in parallel by associating each thread-block with an A, and each thread-block computes the composition scores Φᵢ (A, B) in sequence for an associated A and for all Bs.

13. The system of claim 12, wherein each thread is associated with a template T inside each of the thread-blocks.

14. The system of claim 13, wherein each of the thread-blocks finds a maximum Φᵢ(A,B) by parallel reduction of ψ(A, B,T) over T using a shared memory.

15. The system of claim 14, wherein parallel reduction comprises:
each of the threads computing ψ(A, B, T);
storing ψ(A, B, T) from each of the threads in an array in the shared memory; and
searching the array for a maximum ψ(A, B, T) over T.

16. A system comprising a computer readable storage to store program code executable by a multi-core processor to:
compute in parallel composition scores Φᵢ(A, B) for each of i pages in a document;
compute in parallel coefficients (τᵢ) for each of the i pages in the document; and
producing an optimal document based on the composition scores (Φᵢ) and the coefficients (τᵢ).

17. The system of claim 16, wherein the composition score Φ(A, B) is computed in parallel for each content pair (A, B).

18. The system of claim 16, wherein the composition score Φ(A, B) is computed in parallel for different As and fixed Bs.

19. The system of claim 16, wherein the composition score Φ(A, B) is computed in sequence for a fixed A and different Bs.

20. The system of claim 16, wherein the composition score Φ(A, B) is computed in parallel for fixed As and fixed Bs.
